(19) United States
(12) Patent Application Publication
(10) Pub. No.: US 2016/0196749 A1
(43) Pub. Date: Jul. 7, 2016

(54) METHOD FOR ASSISTING HAULING TRUCKS AT WORKSITE

(71) Applicant: Caterpillar Inc., Peoria, IL (US)

(72) Inventors: Qi Chen, Dunlap, IL (US); Paul R. Friend, Morton, IL (US)

(73) Assignee: Caterpillar Inc., Peoria, IL (US)

(21) Appl. No.: 15/068,738

(22) Filed: Mar. 14, 2016

(51) Int. Cl. G08G 1/00; G05D 1/00

(52) U.S. Cl. CPC G08G 1/202; G05D 1/0027; G05D 1/0022

(57) ABSTRACT

A method for assisting a hauling truck to spot a loading position with respect to a loading machine at a worksite includes actuating an implement control unit of loading machine to raise an implement of the loading machine for being identified by the hauling truck. The method further includes receiving at least one parameter associated with the loading position of the hauling truck. The load body of hauling truck is aligned with respect to the raised implement of loading machine in the loading position. The method further includes storing the at least one parameter for loading material from the implement to load body of subsequent hauling trucks, and communicating, via a peer-to-peer communication unit, the at least one stored parameter to subsequent hauling trucks to align the load body of subsequent hauling trucks with respect to the raised implement during subsequent loading operations, until location of loading machine is altered.

### TECHNICAL FIELD

The present disclosure relates to a method of locating hauling trucks with respect to a material loading machine at a worksite, and more particularly relates to a method for assisting the hauling trucks to spot a loading position with respect to the material loading machine.

### BACKGROUND

During material transfer in a worksite, a hauling truck needs to be aligned in a loading position with respect to a loading machine. Typically, an operator of the loading machine operates a communication device of the loading machine to communicate with the hauling truck. The operator assists the hauling truck to arrive at the loading position, at which an implement of the loading machine is able to unload the material into the hauling truck. However, conventionally, such assistance required by the hauling truck employs Global Positioning System (GPS) and other additional sub-systems, which adds to the cost of the loading machine. In addition, such assistance may involve more time, resulting in reduced efficiency.

U.S. Pat. No. 9,052,716, hereinafter referred to as the '716 patent, describes a dump truck parking position/direction indication system, hereinafter referred to as “the system”. The system allows an operator of a loading machine to determine a parking position and a parking direction of a dump truck. The system includes a bucket position detection device which detects the position of a bucket of the loading machine. The system further includes a locus calculation device which calculates a movement locus of the bucket based on the positions of the bucket detected by the bucket position detection device. The system further includes a parking position/direction determination device which determines the parking position and the parking direction of the dump truck based on the movement locus calculated by the locus calculation device. The system further includes an output device which outputs the parking position and the parking direction of the dump truck determined by the parking position/direction determination device. Owing to such calculation of movement locus and presence of multiple devices, the '716 patent may render a process of determination of the parking position complex, non-economical and time consuming.

### SUMMARY OF THE DISCLOSURE

In an aspect of the present disclosure, a method for assisting a hauling truck to spot a loading position with respect to a loading machine at a worksite is provided. The loading machine is configured to load material to the hauling truck. The method includes actuating an implement control unit of the loading machine to raise an implement of the loading machine to a predetermined height for being identified by the hauling truck and for loading the material to the hauling truck. The hauling truck includes a load body to receive the material from the implement of the loading machine. The method further includes receiving, via a communication module of the hauling truck, at least one parameter associated with the loading position of the hauling truck. The hauling truck includes a positioning system to determine the at least one parameter. The load body of the hauling truck is aligned with respect to the raised implement of the loading machine in the loading position. The method further includes storing the at least one parameter for loading material from the implement to load body of subsequent hauling trucks. The method further includes communicating, via an integral communication module of the loading machine, the at least one stored parameter to the subsequent hauling trucks to align the load body of subsequent hauling trucks with respect to the raised implement during subsequent loading operations, until a location of the loading machine is altered. The integral communication module includes a peer-to-peer communication unit.

Other features and aspects of this disclosure will be apparent from the following description and the accompanying drawings.

### BRIEF DESCRIPTION OF THE DRAWINGS

FIG. 1 is a schematic view of a worksite showing loading and unloading operations of a loading machine and hauling trucks, according to an embodiment of the present disclosure;

FIG. 2 is block diagram of a system for establishing a communication between the loading machine and the hauling truck;

FIG. 3A is a schematic diagram illustrating spotting of a loading position by the hauling truck;

FIG. 3B is a schematic diagram illustrating the hauling truck located at the loading position and storing of the loading position by the loading machine;

FIG. 4A is a schematic diagram illustrating a subsequent hauling truck arriving towards the loading position;

FIG. 4B is a schematic diagram illustrating the subsequent hauling truck located at the loading position; and

FIG. 5 is a flow chart of a method for assisting the hauling truck to spot the loading position.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claim.

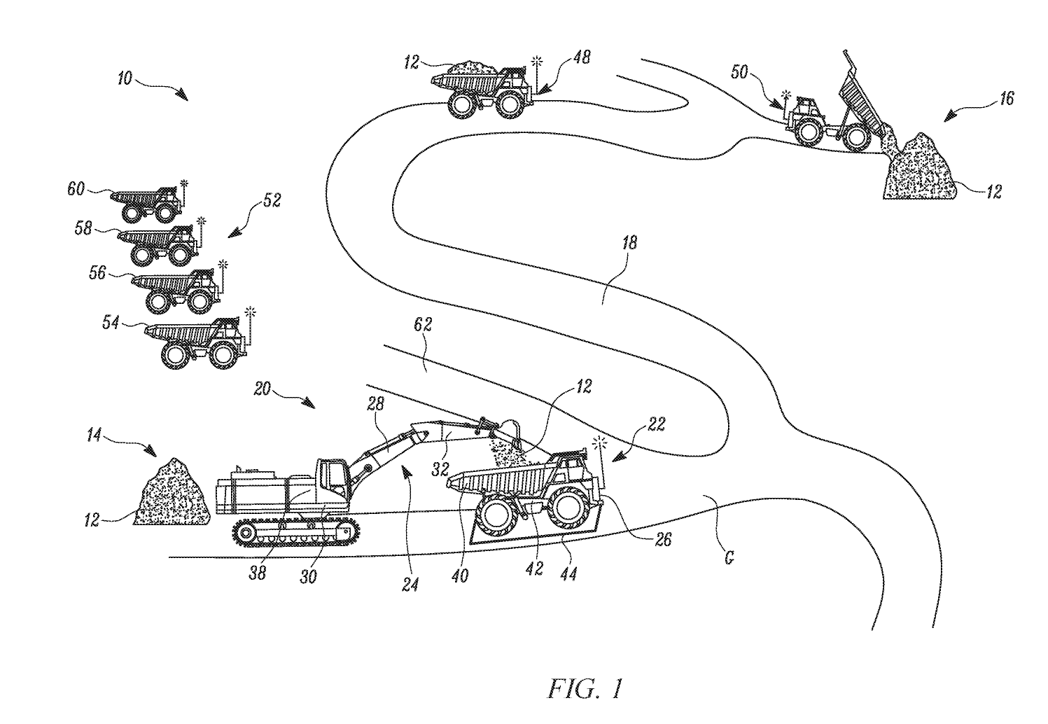

Referring to FIG. 1, a schematic view of a worksite 10 that includes multiple simultaneously-operable machines performing a variety of predetermined tasks is depicted. The worksite 10, for example, may be a mining site, a landfill, a quarry, a construction site, or any other type of worksite known in the art. The predetermined tasks may be associated with altering geography of the worksite 10. The predetermined tasks may include a clearing operation, a leveling operation, a hauling operation, a digging operation, a loading operation, a mining operation, or any other type of operation that functions to alter the geography of the worksite 10. In particular, FIG. 1 illustrates the loading operation, transportation of material, such as aggregate 12, and an unloading operation. The transportation of the material may be carried out from one location in the worksite 10 either to other location in the worksite 10 or to a location outside the worksite 10. Further, the worksite 10 includes a loading location 14 and a dumping location 16 connected to the loading location 14 by a first path 18. The loading location 14 includes multiple and continuous heaps of the material, hereinafter referred to as the aggregate 12, that either needs to be carried to a processing station (not shown) or to the dumping location 16.

The worksite 10 includes a loading machine 20 and multiple hauling trucks 22 for performing the loading operation and the unloading operation, respectively. For the purpose of description, the loading machine 20 is hereinafter referred to as “the machine” 20 and the multiple hauling trucks 22 are hereinafter individually referred to as “the truck” 26. The machine 20 operating at the worksite 10 may be controlled by an operator manually or remotely. In an example, the machine 20 may be embodied as one of an excavator, backhoe loader, wheel loader, skid steer loader, dozer, or a hydraulic mining shovel. However, the machine 20 is shown as an excavator in FIG. 1. The machine 20 includes an arm assembly 24 to aid loading of the aggregate 12 to a truck 26. The arm assembly 24 includes a boom 28 pivotally connected to a chassis 30 of the machine 20, an arm 32 pivotally connected to one end of the boom 28, and an implement 36 coupled to one end of the arm 32. In an example, the implement 36 may be a work tool for assisting in the transportation of the aggregate 12. The machine 20 further includes an implement control unit 38 to actuate and control movement of the arm assembly 24.

The truck 26 illustrated in FIG. 1 is a large mining truck. The large mining truck is also referred as haul trucks. However, it will be understood that the truck 26 may alternatively be any other truck, such as, but not limited to, articulated trucks, on-road trucks, off-highway trucks, or dump trucks capable of transporting the aggregate 12 from the loading location 14 to the dumping location 16. The truck 26 is configured to perform operations related to various industries like mining, forestry, waste management, construction and quarry, transportation, logistics, and agriculture. The truck 26 includes a load body 40 pivotally mounted on a frame 42 of the truck 26. The load body 40 is adapted to receive, transport, and dump the aggregate 12 at the dumping location 16. The aggregate 12 may include construction material and/or other materials, such as sand, gravel, stones, rocks, soil, excavated material, asphalt, coal, mineral ores, and the like.

Further, as shown in FIG. 1, the truck 26 is stationed at a location 44 with respect to the machine 20 at the worksite 10 for receiving the aggregate 12 from the implement 36 of the machine 20. At the location 44, the truck 26 is stationed in a manner, such that the load body 40 of the truck 26 is disposed below the implement 36 and aligned with respect to the implement 36 of the machine 20. The implement control unit 38 aids in raising the implement 36 to a predetermined height ‘H’. It should be understood that the predetermined height ‘H’ of the implement 36 of the machine 20 may vary based on the type of truck employed for transporting the aggregate 12 and a height at which the load body 40 is disposed from a ground surface ‘G’ of the worksite 10. In the raised condition of the implement 36, the aggregate 12 is loaded into the load body 40 from the implement 36. For the purpose of description, a position of the truck 26 at the location 44 is considered as a loading position 46. That is, the implement control unit 38 actuates the implement 36 for loading the aggregate 12 to the load body 40 when the truck 26 is located at the loading position 46.

FIG. 1 also includes another truck 48 loaded with the aggregate 12 is in transit from the loading location 14 towards the dumping location 16. In addition, a ‘dumping state’ of a truck 50 is illustrated in FIG. 1. The ‘dumping state’ of the truck 50 may be understood as an operation state of the truck 50 during which the truck 50 unloads the aggregate 12 at the dumping location 16. It will be understood that the truck 48 also undergoes the ‘dumping state’ once the truck 48 reaches the dumping location 16.

The worksite 10 further includes a docking location 52 for allowing the trucks to gather at a single point, so that the trucks may be deployed to a loading location 14 at the worksite 10 when required. The docking location 52 includes multiple trucks, such as trucks 54, 56, 58, and 60. The trucks 48 and 50 are also directed towards the docking location 52 after dumping the aggregate 12 at the dumping location 16. Further, the docking location 52 is connected to the loading location 14 by a second path 62.

In operation, the implement control unit 38 actuates the arm assembly 24 to raise the implement 36 of the machine 20. Such actuation causes the implement 36 to be disposed at a predetermined height ‘H’ for being identified by a truck, such as the truck 26, stationed in the docking location 52. The machine 20 may include a lighting device which is lit when the machine 20 wants to initiate the loading operation. Such lighting of the lighting device prevents instances of the truck 26 arriving near the machine 20 when there is no loading operation needs to be carried out. In addition, the lighting device also prevents any casual raise of the implement 36 to be misunderstood by a driver of the truck 26.

At an instance where the machine 20 wants to initiate the loading operation, initially the implement 36 may be raised to a first height ‘H1’ for allowing the truck 26 to arrive at the loading location 14 through the second path 62. On arrival of the truck 26 at the loading location 14 and more particularly at the location 44, the implement 36 may be further raised to a second height ‘H2’ based on the height of the load body 40 of the truck 26. When the truck 26 is located at the loading position 46, the implement control unit 38 actuates the implement 36 to unload the aggregate 12 to the load body 40 of the truck 26. Once the load body 40 is filled with the aggregate 12, the truck 26 travels to the dumping location 16 via the first path 18. In order to proceed with subsequent loading operations, the implement 36 is again raised to the predetermined height ‘H’ for being identified by a subsequent truck, such as the truck 54. Accordingly, the truck 54 arrives at the loading location 14 for receiving the aggregate 12 into the load body 64. The loading operation may be carried out until the aggregate 12 is completely transported to the dumping location 16.

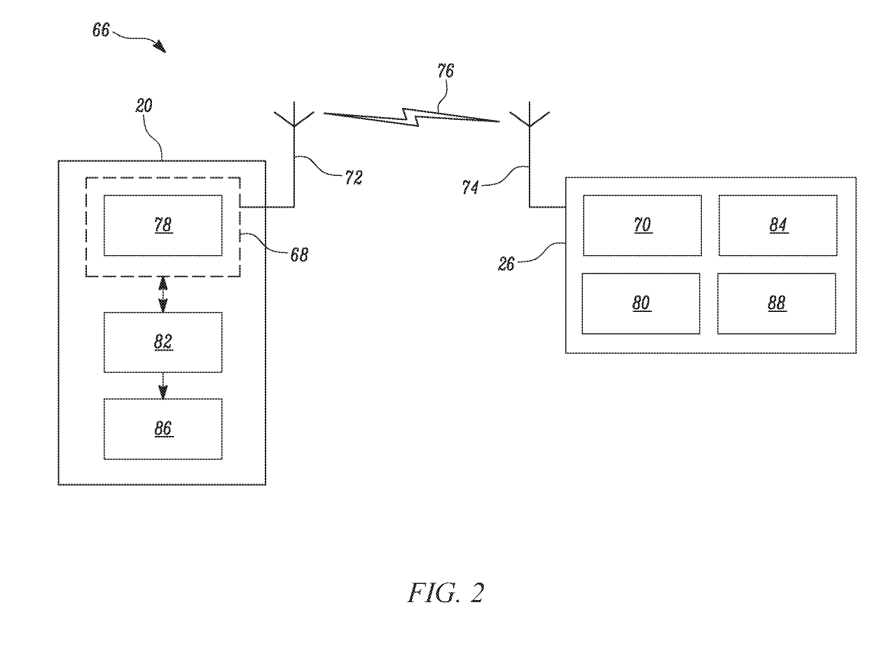

FIG. 2 illustrates a block diagram of a system 66 for establishing a communication between the machine 20 and the truck 26. The communication allows assisting the truck 26 to spot the loading position 46 with respect to the machine 20. The system 66 includes a first communication module 68 deployed in the machine 20 and a second communication module 70 deployed in the truck 26. The first communication module 68 and the second communication module 70 aids in communication between the machine 20 and the truck 26. The system 66 further includes a first antenna 72 disposed in the machine 20 and a second antenna 74 disposed in the truck 26. In an example, the first antenna 72 and the second antenna 74 may be replaced with any other signal transmission devices that are adapted to transmit signal 76 in the worksite 10. The first communication module 68 is an integral communication module that is deployed in the machine 20 during production of the machine 20. The first communication module 68 includes a signal transmission unit 78 for generating signals. In an example, the signal transmission unit 78 may be embodied as a WiFi® unit or a peer-to-peer communication unit. It will be understood that the signal transmission unit 78 may be coupled to the first antenna 72 for transmitting the signal 76 generated by the signal transmission unit 78.

The system 66 further includes a first control module 82 deployed in the machine 20 and a second control module 84 deployed in the truck 26. In an example, each of the first control module 82 and the second control module 84 may be embodied as a processor that includes a single processing unit or a number of processing units, all of which include multiple computing units. The explicit use of the term ‘processor’ should not be construed to refer exclusively to hardware capable of executing a software application. Rather, in this example, each of the first control module 82 and the second control module 84 may be implemented as one or more microprocessor, microcomputers, digital signal processor, central processing units, state machine, logic circuitries, and/or any device that is capable of manipulating signals based on operational instructions. Among the capabilities mentioned herein, the first control module 82 and the second control module 84 may also be configured to receive, transmit, and execute computer-readable instructions.

The first control module 82 is coupled to the signal transmission unit 78. As such, the first control module 82 may be configured to receive and transmit inputs from and to the signal transmission unit 78. Further, the first control module 82 may be connected to a first display module 86 for displaying information to the operator of the machine 20, received from the truck 26.

The second communication module 70 of the truck 26 may be embodied as a trans-receiver. Further, the second control module 84 may be coupled to the second communication module 70 for receiving inputs from the second communication module 70. The second communication module 70 is configured to receive signal 76 from the machine 20. Although FIG. 2 illustrates the second communication module 70 deployed in truck 26, it should be understood that the second communication module 70 is deployed in each of the trucks 54, 56, 58, and 60. The second communication module 70 can communicate with the first communication module 68 when the trucks 26, 54, 56, 58, and 60 are within a predefined distance ‘D’ from the machine 20. The predefined distance ‘D’ may be understood as a maximum distance for which the signal 76 can be transmitted by the first antenna 72. As such, the second antenna 74 receives the signal 76 when the truck 26, 54, 56, 58, and 60 arrive within the predefined distance ‘D’ with respect to the machine 20. The second control module 84 receives the inputs via the second antenna 74. On receipt of the inputs, the second control module 84 may be configured to indicate to driver of the trucks 26, 54, 56, 58, and 60 about information associated with the received input. For example, the second control module 84 may be coupled to a second display module 88 deployed in the truck 26.

Each of the trucks 26, 54, 56, 58, and 60 further include a positioning system 80 to determine at least one parameter associated with the loading position 46. In on example, the positioning system 80 may be at least one of a Global Positioning System (GPS), a Global Navigation Satellite System (GNSS), and an Inertial Measurement Unit (IMU). The IMU allows a GPS receiver to function when GPS signals are unavailable in the worksite 10. Further, the at least one parameter associated with the loading position 46 may be longitude and latitude of the loading position 46. In an example, the at least one parameter may also include contours in and around the loading position 46. The second control module 84 is configured to receive the at least one parameter and convert the at least one parameter to packets of data, so that the packets of data can be efficiently transmitted to the machine 20 via the signal 76.

Although the description herein describes assisting the truck 26 to spot the loading position 46 with help of few devices and methods, it should be understood that the methods described herein are not limiting. Rather, the devices and the methods described herein needs to be considered as exemplary arrangements for the purpose of establishing communication between the machine 20 and the truck 26, while also assisting the truck 26 to arrive at the loading position 46.

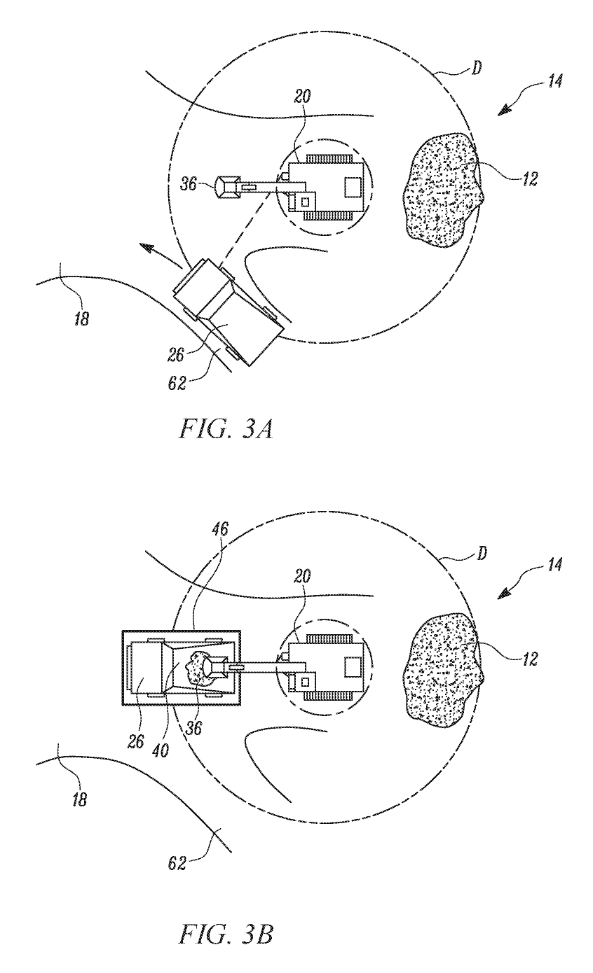

FIG. 3A illustrates a schematic diagram of spotting of the loading position 46 by the truck 26. In particular, FIG. 3A illustrates a top view of the worksite 10 showing the truck 26 arriving at the loading location 14 and aligning the load body 40 with respect to the machine 20. In operation, the first control module 82 actuates the implement control unit 38 to raise the implement 36 of the machine 20 to the predetermined height ‘H’. Subsequently, the truck 26 which is stationed at the docking location 52 may be indicated by the lighting device and the truck 26 arrives in proximity to the machine 20. Further, the truck 26 is manually aligned with the raised implement 36 of the machine 20. That is, the truck 26, being a first truck to arrive at the loading location 14 for being loaded with the aggregate 12, is aligned with the raised implement 36 without any communication aids from the machine 20.

A position at which the load body 40 of the truck 26 is aligned with the raised implement 36 of the machine 20 is referred to as the loading position 46. In such a position, the first control module 82 actuates the implement control unit 38 to load the aggregate 12 to the load body 40 of the truck 26, as shown in FIG. 3B. During such loading operation, the operator of the machine 20 may request the at least one parameter associated with the loading position 46, from the truck 26. In one example, a control panel (not shown) in the machine 20, which is accessible by the operator of the machine 20, may be provided with a button or a lever to initiate such request. Once the operator ascertains that the load body 40 of the truck 26 is aligned with respect to the raised implement 36, the operator may actuate the button or the lever.

On receipt of such request from the operator, the first control module 82 may be configured to actuate the signal transmission unit 78 to generate signal 76. Further, the signal 76 is transmitted to the second antenna 74 of the truck 26 via the first antenna 72 of the machine 20 to obtain the at least one parameter. The signal 76 is received by the second antenna 74 and further communicated to the positioning system 80. Latitude, longitude, and other geographical details of the loading position 46 is gathered by the positioning system 80 and communicated to the second control module 84. As described earlier, the second control module 84 forms packets of data from the inputs received from the positioning system 80. The packets of data including the at least one parameter are transmitted to the machine 20 via the second communication module 70. The at least one parameter, in form of the packets of data, are received by the first communication module 68 of the machine 20 and further communicated to the first control module 82. Further, the at least one parameter is stored in a memory of the first control module 82. In addition, the first control module 82 may be configured to determine an angle at which the arm assembly 24 is disposed, a distance for which the arm assembly 24 was swiveled with respect to the aggregate 12, and a position of the implement 36. These parameters determined by the first control module 82 may be stored in the memory as coordinate points in a vertical plane with respect to the machine 20.

It will be understood that the manner of storing the at least one parameter described herein is for the purpose of description and should not be construed as limiting. The purpose of storing the at least one parameter by the first control module 82 is to better assist subsequent trucks to arrive at the loading position 46 for loading the aggregate 12 to the subsequent trucks.

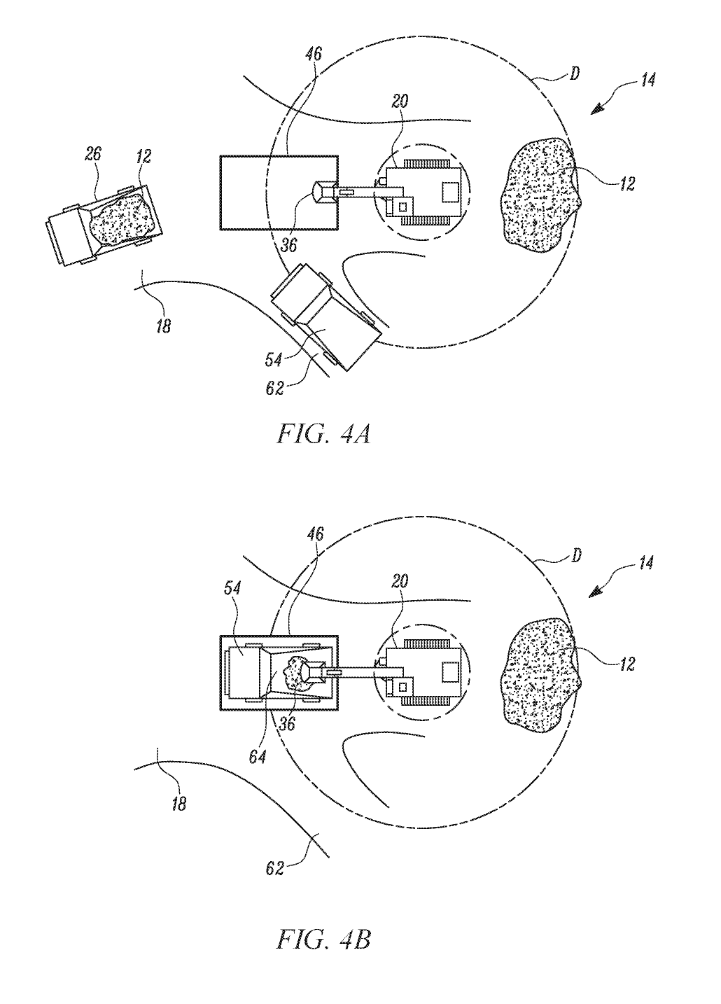

FIG. 4A is a schematic diagram illustrating a subsequent truck, such as the truck 54, arriving towards the loading position 46. Once the driver of the truck 26 determines that the load body 40 has reached a payload capacity due to the loading of the aggregate 12, the driver may instruct the operator of the machine 20 to stop the loading. Subsequently, the truck 26 is moved away from the loading location 14 and travels either towards the processing unit or the dumping location 16, as shown in FIG. 4A. During a subsequent loading operation, the implement 36 of the machine 20 is again raised to the predetermined height ‘H’. Subsequently, the truck 54 stationed in the docking location 52 identifies the raised implement 36 and travels towards the loading location 14 via the second path 62, as shown in FIG. 4A. As the truck 54 arrives within the predefined distance ‘D’, the first control module 82 of the machine 20 initiates communication between the machine 20 and the truck 54. Accordingly, the first communication module 68 generates signal 76 based on the at least one parameter stored in the memory of the first control module 82 and transmits the signal 76 to the truck 54 through peer-to-peer communication.

The at least one parameter is received by the second communication module 70 of the truck 54 and communicated to the second control module 84. With the assistance of the positioning system 80, the second control module 84 determines the location of the loading position 46. The loading position 46 is further displayed in the second display device 88. The positioning system 80 further assists the driver of the truck 54 to drive the truck 54 to the loading position 46 and align it with respect to the raised implement 36. Similarly, the first control module 82 is configured to communicate the at least one parameter to all subsequent trucks 56, 58, and 60, for loading the aggregate 12 to the respective load bodies during subsequent loading operations.

In cases where the operator of the machine 20 ascertains that the aggregate 12 at the loading location 14 is completely transported, the operator may actuate a control lever (not shown) in the machine 20. Based on the actuation of the control lever, the implement control unit 38 may cease further movement of the arm assembly 24. Alternatively, the actuation of the control lever may indicate that the operator of the machine 20 desires to move the machine 20 to a new loading location. In such a condition, the first control module 82 may be configured to erase the loading position 46 from its memory. That is, the first control module 82 actuates the implement control unit 38 and communicates with the subsequent trucks 56, 58, and 60 until the location of the machine 20 is altered.

Although the subject matter of the present disclosure has been described in language specific to few devices and/or methods, it is to be understood that the embodiment disclosed herein are to be taken in an illustrative and explanatory sense, and in no way should be construed as limiting. Rather, the specific features and methods are disclosed as embodiments for assisting the trucks 26, 54, 56, 58, and 60 to spot the loading position 46 with respect to the machine 20 in the worksite 10.

### INDUSTRIAL APPLICABILITY

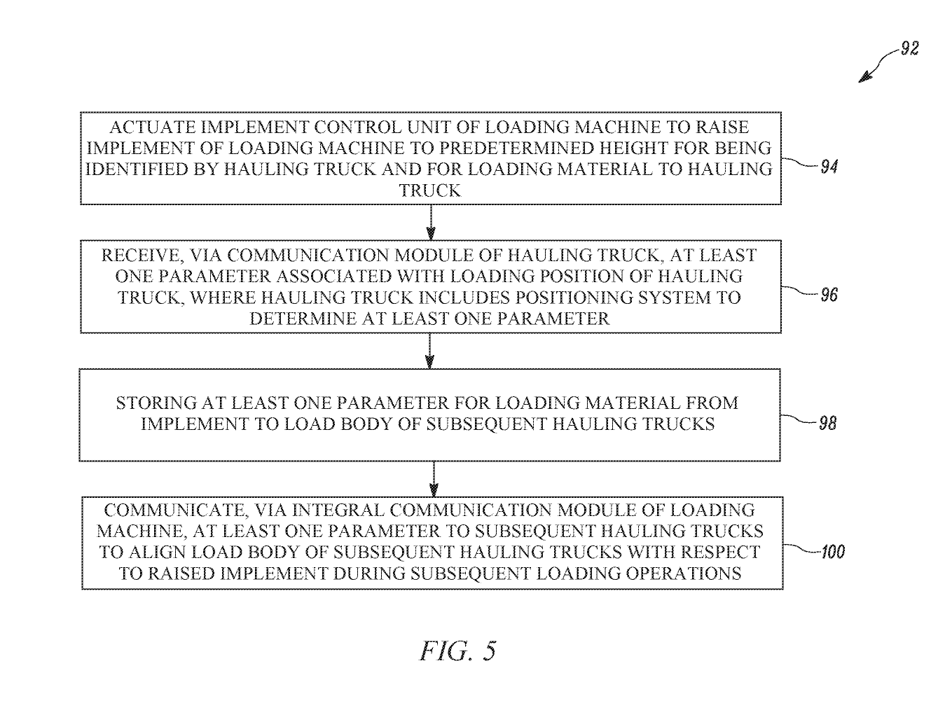

The present disclosure relates to a method 92 for assisting trucks 26, 54, 56, 58, and 60 to spot the loading position 46 with respect to machine 20 at the worksite 10. FIG. 5 illustrates a flow chart of the method 92. The steps in which the method 92 is described are not intended to be construed as a limitation, and any number of steps can be combined in any order to implement the method 92. Further, the method 92 may be implemented in any suitable hardware, such as the first control module 82, to perform the steps of the method 92 readily and on a real-time basis.

For the purpose of description, various steps of the method 92 are described in conjunction with FIGS. 1-4 of the present disclosure. At step 94, the method 92 includes actuating the implement control unit 38 of the machine 20 to raise the implement 36 of machine 20 to the predetermined height ‘H’. In such raised condition of the implement 36, the machine 20 is being identified by the truck 26 for loading the aggregate 12 to the load body 40 of the truck 26.

At step 96, the method 92 includes receiving, via the second communication module 70, at least one parameter associated with the loading position 46 of the truck 26. In one example, the at least parameter includes at least one of longitude, latitude, and contours in and around the loading position 46. The truck 26 includes the positioning system 80 to gather the at least one parameter. The present disclosure also provides the system 66 for establishing the communication between the machine 20 and the trucks 26. At step 98, the method 92 includes storing the at least one parameter for loading the aggregate 12 from the implement 36 to load body of subsequent trucks, such as the trucks 54, 56, 58, and 60. At step 100, the method 92 includes communicating the at least one stored parameter to each of the subsequent trucks 54, 56, 58, and 60 during subsequent loading operations, until a location of the machine 20 is altered.

Since the communication is aided by the integral communication module of the machine 20, the present disclosure overcomes requirement of any additional sub-systems, such as Global Positioning System (GPS) and Global Navigation Satellite System (GNSS), to be deployed in the machine 20 for guiding and assisting the trucks 26, 54, 56, 58, and 60 to spot the loading position 46. As such, the present disclosure eliminates costs associated with employing such sub-systems and maintenance costs associated with maintaining such sub-systems in the worksite 10. The integral communication module of the machine 20, as described earlier, may include the WiFi® unit or a unit that is capable of enabling peer-to-peer radio communication. These units incurs less costs during its installation in the machine 20 and assists in various other operations of the machine 20 in the worksite 10 besides assisting the trucks 26, 54, 56, 58, and 60. Therefore, the present disclosure proposes to employ already existing units in the machine 20 to assist the trucks 26, 54, 56, 58, and 60.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for assisting a hauling truck to spot a loading position with respect to a loading machine at a worksite, the loading machine configured to load material to the hauling truck, the method comprising:
actuating an implement control unit of the loading machine to raise an implement of the loading machine to a predetermined height for being identified by the hauling truck and for loading the material to the hauling truck, wherein the hauling truck includes a load body to receive the material from the implement of the loading machine;
receiving, via a communication module of the hauling truck, at least one parameter associated with the loading position of the hauling truck, wherein the hauling truck includes a positioning system to determine the at least one parameter, and wherein the load body of the hauling truck is aligned with respect to the raised implement of the loading machine in the loading position;
storing the at least one parameter for loading material from the implement to load body of subsequent hauling trucks; and
communicating, via an integral communication module of the loading machine, the at least one stored parameter to subsequent hauling trucks to align the load body of subsequent hauling trucks with respect to the raised implement during subsequent loading operations, until a location of the loading machine is altered, wherein the integral communication module includes a peer-to-peer communication unit.
